(19) United States
(12) Patent Application Publication
(10) Pub. No.: US 2009/0031207 A1
(43) Pub. Date: Jan. 29, 2009

(54) Dynamic Method for the Visual Rendering of Data Display and Input Windows on a Computer Screen

(75) Inventor: Rick Molenaar, Nice (FR)

Correspondence Address: YOUNG & THOMPSON, 209 Madison Street, Suite 500, ALEXANDRIA, VA, 22314, US

(73) Assignee: Amadeus S.A.S., Biot (FR)

(21) Appl. No.: 11/886,659

(22) PCT Filed: Mar. 29, 2006
(86) PCT No.: PCT/EP2006/061150

§ 371 Date: Sep. 19, 2007

Related U.S. Application Data
(60) Provisional application No. 60/669,006, filed on Apr. 7, 2005.

(30) Foreign Application Priority Data
Apr. 6, 2005 (EP) 05102704.3

(51) Int. Cl. G06F 17/00

(52) U.S. Cl. 715/224

(57) ABSTRACT

The invention concerns a method for visual rendering of data display and input windows on a computer screen. The windows are opened with a browser by a remote Web site user. In response to a request emitted by the user's browser the site returns thereto, via the network whereon they are connected, a generic form of the requested page not including any pre-positioning information. The browser, during a brief display of the generic form of the page, captures the dimensions of the displayed elements, calculates new display widths and redimensions the elements. Thereafter, the browser displays permanently the page whereof the elements have been adjusted to obtain a good visual rendering. The generic form of the page can therefore be defined independently of the user's display means and in particular does not require using a table for positioning the elements to be displayed.

### TECHNICAL FIELD OF THE INVENTION

This invention relates to the graphic interfaces used for displaying and collecting information from a screen connected to a computer or any similar device. It describes more particularly a method for dynamically adapting the display and the data collection fields to the special environmental characteristics peculiar to a user, and to the choices and modifications carried out by the latter, such as the width of the display window or the language chosen for dialoguing with the software application selected.

### STATE OF THE ART

With the explosive development of the Internet, and in view of its main application, the Web or “worldwide web”, which makes available to the users ever increasing quantities of information in the form of pages accessible by means of a browser, the problem of visualising these pages on any type of computer screen and similar devices of ever increasing variety arose at a very early stage. There is a wide variety of screen types, particularly as the Web is now accessible not only from fixed stations such as office computers or workstations which have large, even very large screens, but also from portable computers and devices including those of personal assistants or even so-called multimedia wireless telephones whose display capacities are then much lower.

In a first development phase of the Web and the Internet the pages accessible to the users from increasingly numerous sites and implemented by commercial organisations, administrations and all kinds of other organisations, including special organisations, contained essentially static information with fixed formatting generally adapted to a particular screen standard or display windows such as those generated by one or other of the browsers available for consulting and displaying these pages on a computer screen. Currently the most widely used of these browsers is known by the name “Internet Explorer”, and is in fact included in the “Windows” operative system distributed by the American company “Microsoft Corporation”. This is the operative system installed in most computers throughout the world. However, other browsers are also used, in particular “Netscape”, the browser from the American company “Netscape Communications Corporation”, which enjoyed a great deal of success but lost its pre-eminence at the end of the 1990's. Netscape also created a foundation known by the name of “Mozilla”, the purpose of which is to promote the development of browsers whose source code is available free of charge so that it can be modified and redistributed within a context of community development. A new browser, known by the name of “Firefox”, is derived directly from it and is enjoying growing success.

Where static pages are displayed, the only measure sometimes taken to the benefit of the user by the site designer consists in a simple warning indicating that the page consulted would be much more clearly visible if the user were to use this or that browser and a screen allowing a display window of at least 1024×768 elementary pixels or display points, for example. Beyond this simple warning, numerous improvements have been made over the years to provide each user of Internet sites effectively the page format that is best adapted to the screen he/she has and to the size of the window used. This is particularly the case of commercial sites which have to make special efforts to retain their customers whatever the equipment and software used by them. Other parameters must also be carefully considered. The display language of the information is particularly important for sites selling services or goods. In fact, the display of information, in a language which would not be known to the customer, makes any transaction impossible. The availability of a site in several languages then poses the problem, as far as the display is concerned, that the translation of a text will vary considerably from one language to another in terms of the number of words to be used and the number of letters of these words when ideograms are not used.

Moreover, all important commercial sites, and many others, are no longer content to display information but require the user to interrogate the site, which itself has access to a database. This is the case, for example, of travel agencies which have to access timetables of airlines operating at world level or to reservations of international hotel chains. The travel agency, or the private individual who interrogates such a site, must be able to do so from anywhere in the world in a language he or she knows. In this example the customer will of course want to know first of all the timetables and fares of a particular flight before possibly completing an “online” transaction which will ask him/her to communicate on site, in a secured environment, a credit card number for charging the transaction. The information is input by the user, at the site destination, in numerous forms, among others: by clicking on buttons, by entering text in a window, or by making a choice from a drop-down list. These are means of communicating with the site which forms part of the elements to be displayed on the user's screen.

Depending on the particular use a customer wishes to make of a site, he or she must also have the possibility of not displaying certain elements which would be of no use to him/her. This involves the need for additional personalisation of the display windows and collection of data.

To obtain these results, numerous solutions have been proposed which often bring to the site itself all the difficulties and complexity of information. For example, it is possible to provide for the issue from the site, for a given page, as many variants as there are different cases of display to be provided or, at the very least, sufficient variants to expect to satisfy more or less all potential users. For the preliminary transactions accompanying the connection to a Web site by the customer's browser, the site is designed so that it is capable of acquiring sufficient information on the actual display capacities of its customer. The site may then select the best possible variant of the page requested that will be likely to satisfy the latter.

This procedure suffers from numerous disadvantages. The most restrictive element of these is without doubt the fact that the designer of the site must provide for the storage of as many display options, i.e. templates (“templates” in the English technical literature on this subject) as there are combinations to be considered to satisfy all users of the site. There may be a large number of templates to be stored, which means that all the more coding effort must be made to implement the site and also requires that each template of each of the pages be tested.

Another disadvantage is that the template is selected at the time of connection to the site. If the user then decides to change the display window, its width for example, no adaptation will be made if no adequate mechanism has been provided for this.

More recently more sophisticated display methods have been proposed such as that described in the patent application submitted to the American Patent Office (USPTO) under number 2003/0222922, published on 4 Dec. 2003 and entitled “Automatic Layout Generation”. Although much less rigid than the template method mentioned above, the method of this patent application nevertheless makes use of layout styles which describe a preferred display topology specifying, for example, a display in 3 columns. However, the elements to be displayed must be a multiple of a standard width and are positioned in the same row where their width allows this. The layout style is selected according to the size of the display window and the standard width. Here too numerous layout styles must be provided and must be tested in the user environment.

Within the same concept another display technique often used for aesthetic reasons (the elements to be displayed are well distributed and aligned) consists in defining a table structure by using the corresponding markers of the HTML language “Hyper-Text Markup Language”, the standard language used for coding the pages of the Web sites. Such a display technique, based on the use of tables whose rows have a hierarchical dependence, is described for example in a publication of the World Intellectual Property Organisation (WIPO) under reference WO 2004/109557 and entitled “Flexible, Dynamic Menu-based Web-page Architecture”.

Although it proposes a display technique based on the use of tables, the above publication does not hesitate to emphasise all the difficulties associated with their use. In particular explicit mention is made in the body of the description of this invention of the fact that control of tables of variable and flexible sizes is considered extremely difficult, that this may pose severe problems in terms of performance for their re-dimensioning, and that it may be extremely difficult to predict how exactly it will be operated as a function of changes in the display dimensions.

The general object of the invention is therefore to propose a dynamic display method which provides means available to a user for consulting the pages of a Web site and obtain this result from a generic code which does not necessitate pre-defining the position of the elements to be displayed.

A further particular object of the invention is to obviate the need to use a table structure to allow positioning of the elements to be displayed.

A further object of the invention is to allow personalisation of the display by the user who does not require a modification of the source code.

Yet another object of the invention is to use the actual size of the elements to be displayed so that they can be combined in the best possible manner during the display.

The other objects, features and advantages of this invention will be apparent to the specialists on examining the following description and accompanying drawings. It is understood that other advantages may be incorporated.

### SUMMARY OF THE INVENTION

A method for visual rendering of data display and input windows on a computer screen is described. The windows are opened by a user of a remote Web site using a browser to transmit a request to the site via a network. The site returns a generic form of the page to the browser which includes no information for pre-positioning of the elements to be displayed. In a first phase, the browser briefly displays the page. During this phase it captures the sizes of the displayed elements, carries out a calculation of new display widths of the elements and proceeds to re-dimension. The browser then permanently displays the page after the elements have been adjusted to obtain a satisfactory visual rendering. The generic form of the page is characterised in that it does not include a positioning table. The elements to be displayed include, in particular, labels, data control and input fields and images. Certain elements are associated to be displayed together. The associated elements are contained in a table serving as an inseparable container. The calculation of new widths is based on the size of the widest element or elements to be displayed. The permanent display is updated if the display window of the browser is modified by the user. The capture of the sizes, the calculation of new widths and re-dimensioning are carried out by a code residing in the browser. Since personalisation options enable the user only to display some of the elements sent in the generic form of the page, the personalisation is followed by an update of the permanent display. Only the labels contained in the generic code need to be modified to adapt a page to a language.

### BRIEF DESCRIPTION OF THE FIGURES

The purposes, objects as well as the features and advantages of the invention will be more clearly apparent from the detailed description of an embodiment of the latter, which is illustrated by the following accompanying drawings in which:

FIG. 1 shows the different display phases of a window including labels and data input fields.

FIG. 2 describes the stages of the display of a generic page returned by the Web site.

FIG. 3 describes the stages of capture of the sizes of the elements to be displayed.

FIG. 4 describes the stages of re-dimensioning of the elements to be displayed.

FIG. 5 shows, in three window examples, the high flexibility of display of the invention.

The attached drawings are given by way of examples and do not limit the scope of the invention.

### DETAILED DESCRIPTION OF THE INVENTION

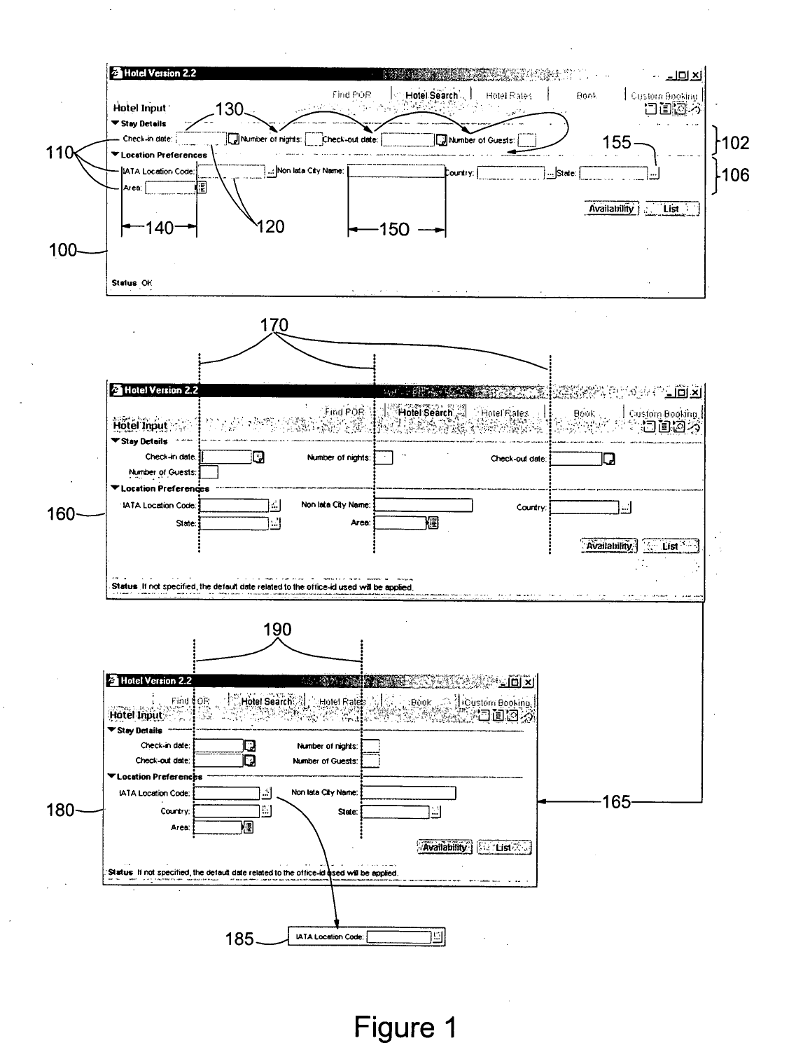

FIG. 1 summarises the mode of operation of the invention. In a first phase, at the request of the browser of a user who wishes to consult a site, the page requested is sent to the latter. This is the generic form of the page in which no positioning of the elements to be displayed is included in the HTML language used to describe it. This page may therefore be sent to any user regardless of his means of display. In this first phase the visual rendering of the generic page conforms, for example, to that of the top window (100) of FIG. 1. The labels, i.e. the brief texts describing the fields, for example (110), and the data input and associated control fields, for example (120), are displayed without defined positioning in the window (100), one following the other (130). This method of display is intrinsic to the HTML language and requires no additional specification. The elements are displayed in the order in which they are called by the source code of the HTLM page. The so-called “online” elements appear from left to right and from top to bottom, occupying all the available space. This is obviously the case of the text, as in the present document, but other elements may be included, in particular images, drawings or icons (155).

The elements which are not on line constitute inseparable blocks which are stacked vertically from top to bottom and are also displayed in the order in which they are called by the source code, each potentially occupying the entire width of the page. This is case of successive paragraphs and titles of a text as described in this invention. In the example in FIG. 1 there are two sections which have been defined in the source code (102, 106) and which are stacked vertically.

The advantage that may be derived from this method of coding a page, which must be read by the browser of a customer, will readily be understood. No positioning information has been included in the source code, i.e. in the code residing in the site consulted by the user, a code which is downloaded by his/her browser. The site designer does not have to concern him/herself with the display capacities of the users. He/she only has to develop one generic code. The more intrinsically simple this code is the better tested it is in its development phase.

The HTML pages coded on the basis of this approach are said to be coded in the float mode as opposed to another mode which is said to be the positioning mode. In the latter mode the site designer must pre-define the position of each of the elements he/she wants to display on the user's screen. Among numerous methods that have been proposed, the most frequently used having been discussed in the chapter on the state of the art, a method that has proved very successful consists in using a table to define the topology of a Web page. The elements to be displayed are then arranged in the cells of the table. However, the visual rendering is generally good at the cost of a certain degree of rigidity, for example the number of cells is predetermined, but this in particular takes up all the effort of the site designer in coding. The designer must pay particular attention to the display capacities of the end user and also to the local peculiarities, especially the display language of the text and of the labels. When the display capacities of the latter do not meet with expectations, the result may then be extremely disappointing.

Thus if the float mode enables the coding of a Web page to be considerably simplified, the visual rendering of the first phase of the method according to the invention is far from satisfactory. However, the sole purpose of this first stage is to obtain the effective display size of the labels and data input and control fields in the window opened by the user with his/her browser. The display of the generic form of the page (100) is very transient. In practice this first phase passes the user unnoticed. The widest sizes of the label (140) and the input field (150) are then stored, which will enable the visual rendering to be modified locally to make it more attractive. In fact it is a property of the HTML language and of the browsers which display the Web pages that it does not have to supply the width of the elements to be displayed. It is the browser with the graphic user interface (GUI) of the computer that calculates the effective display width as a function of the content and available space. This gives the method according to the invention a major advantage, particularly when it is necessary to adapt the display of the fields to all the languages that have to be supported by an international application of a product since it requires no modification of the source code other than by simple translation of the labels, without other modifications.

At this stage of the description of the invention it may be observed that the publication quoted above in the chapter on the state of the art and bearing the reference: WO 2004/109557, mentions a so-called “Autolayout Algorithm”. This is a recommendation of the principle standardisation organisation of the Web, i.e. the W3C, in English the “World-Wide Web Consortium”. If, as in the invention, the algorithm has provided for a first display phase, the latter is used to alleviate the difficulties inherent in the control of a display in the form of a table. These are difficulties that have already been mentioned above and in the chapter on the state of the art. On the other hand, as explained in greater detail below, the invention does not need to use any table to obtain a satisfactory visual rendering.

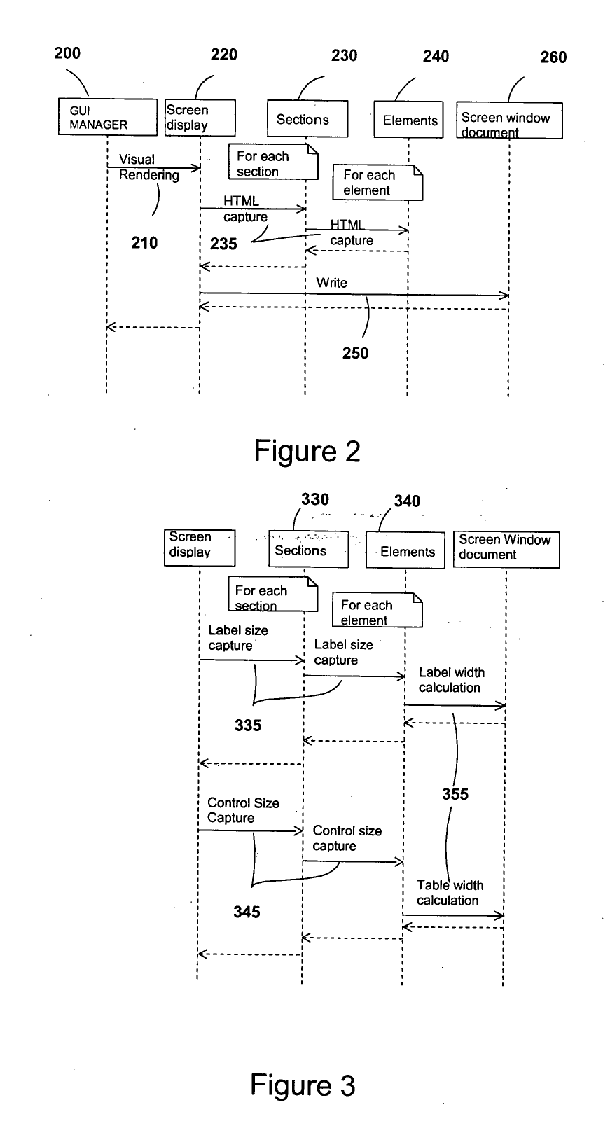

The method according to the invention uses the actual display widths obtained during the first phase described above to modify their visual rendering. The method of obtaining the actual display widths is described in more detail in FIG. 2 and following. In a second phase, therefore, all the labels and input fields of the page are related to the respective maxima measured, which enables the display corresponding to the intermediate window in FIG. 1 (160) to be obtained. The labels and the data fields are then well aligned (170) in the window owned by the browser.

If the display window is reduced (165) the labels and the data input and control fields are rearranged, for example, as shown in the lower window (180) in FIG. 1. The alignment is always conformed to, this time in two columns (190), because it is no longer possible to position three labels and their associated fields within the width of the modified window due to the maximum sizes measured.

It will have been no doubt noted that some of the display elements must remain grouped. For example, as shown in (185), the label, its data input field and the associated icon must be moved together. This is easily achieved, for example, by grouping in the source code, the elements corresponding to a table which becomes a single “online” element that is inserted in the stream of elements to be displayed.

FIG. 1 clearly shows that it is possible to obtain from the same source code, by the method of the invention, a dynamic display having a highly satisfactory visual rendering, without having to resort to positioning information nor use a positioning table for the elements. As discussed above, the use of tables by the HTML language of the source code merely serves, therefore, to group elements that have to remain together and whose purpose is by no means to play the role of a positioning table. There are other methods known to specialists in the design of Web pages and the HTML language that can be used to keep elements grouped during the display without the use of a table. A table acting as a container for the elements that must remain together is merely a very convenient method, as far as the HTML language is concerned, of obtaining this result and its use is therefore preferred for implementing the invention.

It will be observed, particularly in this figure, that the method according to the invention makes it possible, in Section 2 for example, automatically to obtain a display of the elements of this section on two or three rows and in two or three columns. This would not be possible with a single positioning table in the source code or with a layout style.

An additional advantage of the method according to the invention is that only the essential data have to be transmitted via the network. The visual rendering is obtained locally from the generic code of the Web page requested and is obtained essentially with the applicative code, which is downloaded and installed by the users of the application and can be updated whenever a modification is required or an improvement is made. The users may, for example, be travel agencies which have to consult and make hotel reservations from a centralised database using the Internet or a private network (intranet), or a combination of both, and a browser to interpret the HTML language. The local code uses one or other of the options compatible with a Web browser. These are software components interacting with the HTML language and are well known to the persons skilled in the art under names such as Active-X, Javascript or XSL.

At this stage of the description of the invention it will have been noted that the term “Web page”, as it is normally understood, is more restrictive than the term page used by the description of the invention, which assumes the execution of the local code for formatting the generic page at the time it is received from the server, whilst a Web page is normally stored on the server and transmitted as it is for display. However, the term page will continue to be used in the following where it involves the mode of operation of the invention.

FIG. 2 and following describe in more detail the stages of the method of visual rendering of the invention. FIG. 2 corresponds to the first phase discussed in FIG. 1, which involves displaying for a very short time the generic form of the Web page sought.

In this first phase the HTML code must be captured to enable the graphic user interface (GUI) provided in all computers to display the page on the user's screen. In practice the GUI (200) calls the visual rendering operation (210) for the screen (220). Since what is to be displayed generally comprises a plurality of sections (230), each must find the HTML code (235) corresponding to all the elements of the page (240). When the entire code has been found it is used to generate, in the form of a write operation (250), a document object to be displayed in the window opened by the browser (260).

As already seen in FIG. 1, all the elements of the HTML code entered by the page designer consist in this example of a label and an associated data input and control field. To ensure that they remain grouped during the display and form an inseparable element, they are placed in a container, i.e. a table as defined by the HTML language. The invention explicitly requires that each of these tables must be able to be considered an “online” element in the stream of elements to be displayed.

Here it is useful to note that numerous improvements have been made to the HTML code and the browsers over the years. In particular, the adoption of a so-called dynamic version of the HTML language, or even DHTML, from the English “Dynamic HTML”, has provided better control of the pagination of the elements to be displayed. In particular, it enables a page to be changed and interact with the user without having to communicate with the server. And as far as the invention is concerned, DHTML provides access to the elements displayed and to determine their sizes using “JavaScript”, previously mentioned, which is a script language closely integrated in the browsers. DHTML has been present in the browsers since versions 4 of the “Internet Explorer” and “Netscape” browsers. Although in practice there are differences in implementation of DHTML between the different browsers, standardisation has been carried out under the auspices of the DOM group, from the English “Document Object Model”, which acts within the framework of the principal organisation for standardisation of the Web, the W3C, already referred to above.

FIG. 3 describes in more detail the phase of capturing the sizes of the elements which are briefly displayed during phase 1. This is an operation made possible by the adoption of the DHTML. In particular, this involves parameters that enable the size of the labels and controls to be obtained. Numerical properties such as “offsetLeft, offsetWidths”, which specify the physical coordinates and dimensions of the objects related to a parent object (container), are captured during a first display. They enable the effective size of the labels and controls to be obtained.

The stages of this second phase are similar to those described in FIG. 1. The size of the labels (335) and controls (345) are captured for each section (330) and each element (340).

Once all the widths of the labels and controls have been captured, the maximum width (355) of each of the fields can be calculated during the preliminary display by classic software engineering methods. This will enable all the elements to be displayed to be re-dimensioned taking into account the widest element or elements to obtain the intermediate window (160) in FIG. 1.

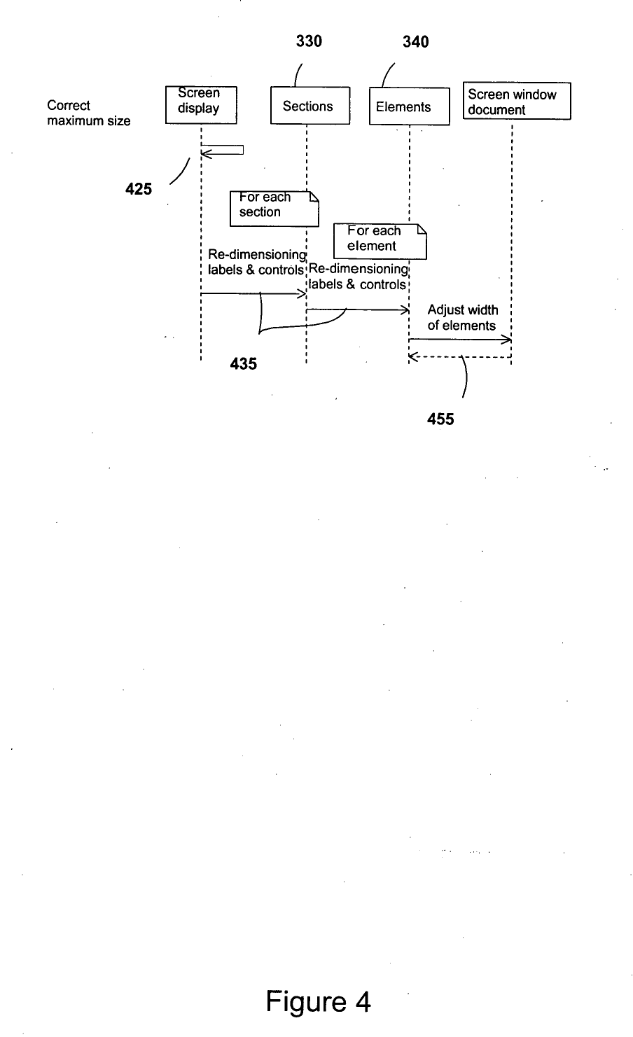

FIG. 4 summarises the re-dimensioning stages required to align the elements to be displayed in the window opened by the user's browser and realign them if the user decides to modify the display window as in the example shown in FIG. 1 (180).

The display function (400) calls the re-dimensioning operation (435), as before, for all the labels and controls of each section. All the elements of the document object to be displayed are then adjusted (455), particularly the containers, i.e. the tables.

One of the results of the re-dimensioning stages is, for example, the window (460) in which the edges (465) of the tables containing the labels and control fields clearly appear for the sole purpose of providing a clearer understanding of the mode of operation of the invention. However, the Web page designers using the method of the invention will of course choose in preference, for clarity of the display, to make the edges of the containers invisible.

To prevent the fields from assuming dimensions that are too large, which would impair the aesthetics of the display, the invention provides that a maximum width can be specified (425). It is this maximum width that is then used for the display. In the case in this figure, if a label is longer than the maximum value it will automatically be moved back at least two lines. In the case of a control field the actual width will be used, but other elements will be prevented from continuing to be displayed horizontally to the right of it. A return to the line will be forced for the elements that follow.

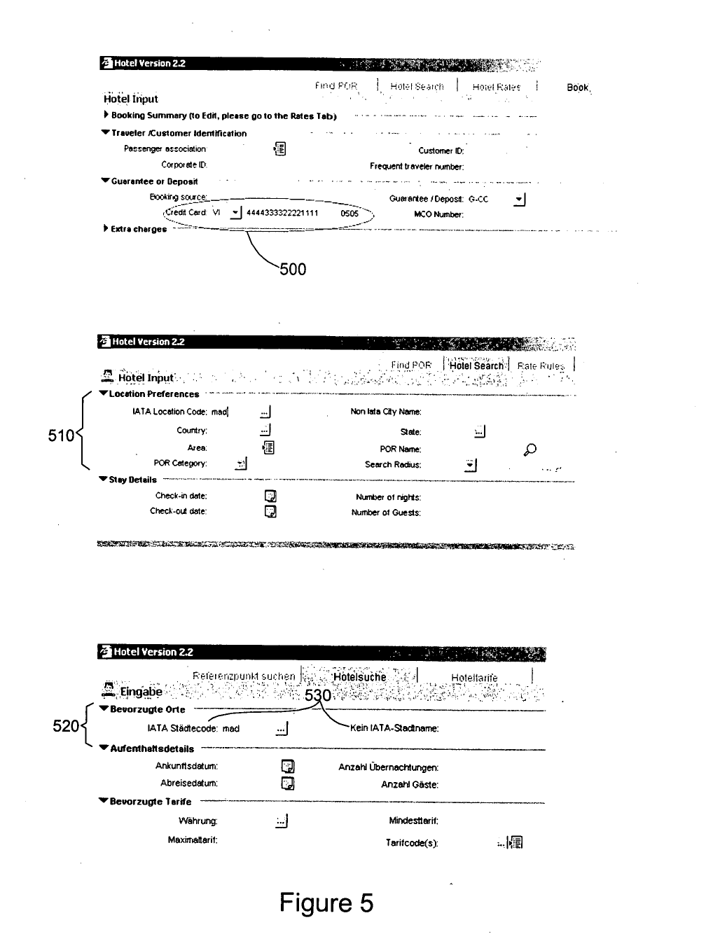

The purpose of FIG. 5 is to illustrate, in three examples of display windows, the considerable flexibility of the invention.

The upper window includes a container (500) which contains two data input fields, just as in the case when it is necessary to enter a credit card type and its associated number. In this case this is an inseparable element which will be displayed as a whole.

The intermediate window shows a first section (510) in which it has been chosen to display 8 elements. In the window at the bottom the user has chosen only to display in this section the name of the city (520). Moreover, the labels on this page are then in the German language (530). The user may decide whether or not to visualise certain elements included in the source code and the display is automatically adjusted.

The personalisation is possible at two levels. At section level each section may be rendered totally invisible. Moreover, a section may be deployed, in which case all the elements are visible, or reclosed, in which case only the text of the section appears.

At element level it may or not be rendered visible.

The users have the choice of deploying or reclosing the sections. This choice is stored and will be respected at the time of the next display.

A configuration panel may be opened by the user to make his or her display choices.

1. A method for visual rendering of display and data input windows on a computer screen, said windows being opened by a user of a remote Web site, wherein said user makes use of a browser to transmit a request to said site via a network, said site sending a page in response to said request, the method characterised in that:
said Web site sends a generic form (100) of said page to said browser, wherein said generic form does not include information on the pre-positioning of the elements to be displayed;
said browser briefly displays said page (250), wherein said display stage includes:
capture of the sizes (335, 345) of the elements displayed;
a calculation (355) of new display widths of said elements;
a re-dimensioning (435) of said elements;
said browser permanently displays said page (160);
thus obtaining a satisfactory visual rendering from said generic form.

2. The method according to claim 1, in which said generic form (100) of said page is characterised in that it does not include a positioning table.

3. The method according to claim 1, characterised in that said elements to be displayed include in particular labels (110), control and data input fields (120) and images (155).

4. The method according to claim 3, in which the elements are associated so that they can be displayed together (185).

5. The method according to claim 4, in which said associated elements are included in a table (465) serving as an inseparable container.

6. The method according to claim 1, in which the stage of calculating new widths is based on the size of the widest element or elements to be displayed (140, 150).

7. The method according to claim 1, in which the permanent display stage includes an updating stage (180) if the display window of said browser of said browser is modified (165) by said user.

8. The method according to claim 1, in which the stages of size capture, calculation of new widths and re-dimensioning are carried out by a code residing in said browser.

9. The method according to claim 8, in which said resident code includes personalisation options enabling said user only to display some (520) of the elements sent in said generic form of the page, wherein said personalisation stage is followed by updating of said permanent display stage.

10. The method according to claim 1 in which only the labels contained in the generic code must be modified to adapt a page to a language (530).

11. A medium readable by a computer containing the instructions of a program executable by said computer, wherein said program implements the method according to claim 1.

12. The method according to claim 2, characterised in that said elements to be displayed include in particular labels (110), control and data input fields (120) and images (155).

13. A medium readable by a computer containing the instructions of a program executable by said computer, wherein said program implements the method according to claim 2.

14. A medium readable by a computer containing the instructions of a program executable by said computer, wherein said program implements the method according to claim 3.

15. A medium readable by a computer containing the instructions of a program executable by said computer, wherein said program implements the method according to claim 4.

16. A medium readable by a computer containing the instructions of a program executable by said computer, wherein said program implements the method according to claim 5.

17. A medium readable by a computer containing the instructions of a program executable by said computer, wherein said program implements the method according to claim 6.

18. A medium readable by a computer containing the instructions of a program executable by said computer, wherein said program implements the method according to claim 7.

19. A medium readable by a computer containing the instructions of a program executable by said computer, wherein said program implements the method according to claim 8.

20. A medium readable by a computer containing the instructions of a program executable by said computer, wherein said program implements the method according to claim 9.
